(19) United States
(12) Patent Application Publication
(10) Pub. No.: US 2025/0238688 A1
(43) Pub. Date: Jul. 24, 2025

(54) PLUG-AND-PLAY MODULE FOR DE-BIASING PREDICTIVE MODELS VIA MACHINE-GENERATED NOISE

(71) Applicant: PAYPAL, INC., San Jose, CA (US)

(72) Inventors: Yunxia Zhao, Scottsdale, AZ (US); Dong Yoon Kim, New York, NY (US); Viswas Guptha Kotturi, Chennai (IN); Yun Wang, New York City, NY (US); Yifan Zhou, San Jose, CA (US); Yi Yang, Manhasset, NY (US)

(21) Appl. No.: 18/421,478

(22) Filed: Jan. 24, 2024

(51) Int. Cl. G06N 5/022

(52) U.S. Cl. CPC G06N 5/022

(57) ABSTRACT

Data features are accessed from a plurality of sources. The data features pertain to a plurality of users. The data features are inputted into a predictive model. An output is generated via the predictive model. The output of the predictive model is inputted into a plurality of adversarial models. The adversarial models include different types of protected attributes. At least some of the protected attributes are non-binary. Noise is introduced to the predictive model via each of the adversarial models of the plurality of adversarial models. The output of the predictive model is updated after the noise has been introduced to the predictive model. One or more decisions involving the plurality of users are generated at least in part via the updated output of the predictive model.

### BACKGROUND

### Field of the Invention

The present application generally relates to machine learning. More particularly, the present application involves improving machine learning modeling via de-biasing techniques.

### Related Art

Over the past several decades, rapid advances in integrated circuit fabrication and wired/wireless telecommunications technologies have brought about the arrival of the information age, where electronic activities and/or online transactions are becoming increasingly more common. Machine learning has been used to predict one or more behavioral characteristics of users in conducting these activities and/or transactions, for example, with respect to a risk of the users defaulting on a loan or a credit line. However, the predictions made by many machine learning models may have inherent biases, for example, biases against a sensitive user attribute, such as race, ethnicity, gender, disability, religion, sexual orientation, etc. As a result, users may be unfairly denied certain opportunities based on the predictions made by conventional machine learning models. Therefore, although existing machine learning models are generally adequate for their intended purposes, they have not been entirely satisfactory in every aspect. What is needed is an improved machine learning model that can remove biases against certain sensitive user attributes and improve prediction accuracy.

### BRIEF DESCRIPTION OF THE FIGURES

FIG. 1 is a block diagram of a networked system according to various aspects of the present disclosure.

FIG. 2 illustrates a simplified block diagram corresponding to a process flow for de-biasing a machine learning model according to embodiments of the present disclosure.

FIG. 3A illustrates how adversarial de-biasing is used to de-bias a gradient boosting tree (GBT) machine learning model according to various aspects of the present disclosure.

FIG. 3B illustrates a plurality of adversarial de-biasing operating in parallel to de-bias a machine learning model according to various aspects of the present disclosure.

FIG. 3C illustrates a process flow according to various aspects of the present disclosure.

FIG. 4 illustrates a graph according to various aspects of the present disclosure.

FIG. 5 illustrates a re-ranking of data features according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is a flowchart illustrating a method of generating a decision based on de-biased machine learning models according to various aspects of the present disclosure.

FIG. 9 is an example computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using machine learning models and machine learning (ML) to evaluate the behavioral characteristics of users. In more detail, a user (e.g., a customer) of a digital wallet provider (or another online platform) may apply for a predefined benefit. As non-limiting examples, the predefined benefit may include a financial product (e.g., a loan or a credit line, reduced rates or fees, and extended grace periods), a status, or a membership. In some cases, the digital wallet provider or the online platform may also proactively determine whether or not to offer the predefined benefit to the user without the user explicitly making the request. In order to determine the risks associated with giving the predefined benefit to the user, the digital wallet provider or the online platform may utilize a machine learning model to predict a likelihood of an occurrence of an event, for example, the probability of a given user being late or missing loan payments, or defaulting on a loan altogether. The digital wallet provider or the online platform may then identify users who are less risky and users who are riskier. The digital wallet provider or the online platform may then offer the predefined benefit (e.g., the loan or the credit line) to the users who have been identified as being less risky, but decline the offering of the predefined benefit to the users who have been identified as being riskier.

However, the machine learning models in the above process often do not sufficiently take into account biases (e.g., biases against certain sensitive user attributes) that may inherently exist in the modeling processes. For example, users may have sensitive attributes that are protected from discrimination by law or other rules or regulations stipulated by a government or by an organization, such as race, ethnicity, gender, place of origin, religion, age, disability, sexual orientation, pregnancy status, color, national origin, familial status, marital status, recipient of public assistance, etc. Ideally, a machine learning model is not supposed to have any biases against users who have one or more of these sensitive attributes. Unfortunately, the algorithms behind many machine learning models have not been carefully configured to recognize and/or remove such biases. As a result, these machine learning algorithms may make predictions that are unfair against users who have one or more of the sensitive attributes and do not accurately predict risks associated with such users. Note that in different embodiments, “biases” can refer to any factor that does not contribute to an accurate prediction or output for a user, e.g., the “bias” has zero or close to zero correlation with an accuracy of the prediction or output.

The present disclosure overcomes the above problem by de-biasing a predictive machine learning model with respect to one or more protected user attributes that each meet a specified classification (e.g., sensitive user attributes, such as race, gender, place of origin, religion, age, disability, sexual orientation, pregnancy status, color, national origin, familial status, marital status, recipient of public assistance, etc.). For example, data features pertaining to a plurality of users may be accessed from a plurality of sources. As non-limiting examples, these sources may include data features collected by an electronic platform (e.g., the platform of a payment provider), data from credit ratings or bureau or agencies (e.g., a credit history or a credit score from EQUIFAX™ or TRANSUNION™), or environmental data (e.g., macro-economic indicators). The collected data features are inputted into a predictive machine learning model. As a non-limiting example, the predictive machine learning model may be a Light Gradient Boosting Machine (LightGBM) model that includes a plurality of trees on a chain. In other embodiments, the predictive machine learning model may be another type of model that is not based on LightGBM.

In various embodiments, the predictive model may be a credit underwriting model, a fraud model, or another suitable model. The predictive model generates an output, which may be a prediction with respect to a probability of an occurrence of an event involving a user. For example, the event may be a negative outcome after the granting of a predefined benefit, such as a user missing payments on a loan (where the loan may be the predefined benefit) or defaulting on the loan altogether. The output of the predictive model is inputted into a plurality of adversarial models.

Each of the adversarial models includes a plug-and-play model (or alternatively, may itself be a plug-and-play model) that is configured to interact with at least the predictive model (e.g., the LightGBM model), as well as other types of machine learning models based on algorithms other than the prediction model (e.g., LightGBM). In other words, the adversarial models may be overlaid on top of the predictive model and do not require modifications to the source code of the predictive model. A new predictive model (which may be a different type of model) may be swapped with the original predictive model, and the adversarial models may still work in conjunction with the new predictive model. Note that although the LightGBM model is used as an example predictive model for the sake of facilitating the ensuing discussions, it is not intended to be limiting unless otherwise claimed. In other words, other types of predictive models may be used in alternative embodiments instead of the LightGBM model.

In some embodiments, each one of the adversarial models is configured to de-bias a different type of protected attribute. For example, one adversarial model may include race as a protected attribute, another adversarial model may include gender as a protected attribute, and yet adversarial model may include age as a protected attribute. At least some of the protected attributes are non-binary. For example, race and age may each have more than two values (e.g., race can be Caucasian, African American, Hispanic, Asian, etc., and age can be 18 years of age, 30 years of age, 50 years of age, 70 years of age, etc.). In some embodiments, instead of having separate protected attributes, multiple protected attributes may be merged into one cross tag, for example, an African American woman who is older than 70 (which include race, gender, and age).

Noise is then introduced to the predictive model via each of the adversarial models. In some embodiments, the noise is introduced by determining a decay function to the introduced noise. In some embodiments, the decay function is performed by ramping down the introduced noise after a predefined number of iterations of noise-introduction has been executed. In some embodiments, a different decay function is customized for each adversarial model of the plurality of adversarial models. In embodiments where the predictive model is the LightGBM model with a sequence of trees, the output of the predictive model inputted into the plurality of adversarial models may include an output from a preceding tree on the chain, and the noise is introduced by the adversarial models to a subsequent tree (e.g., subsequent to the preceding tree) on the chain.

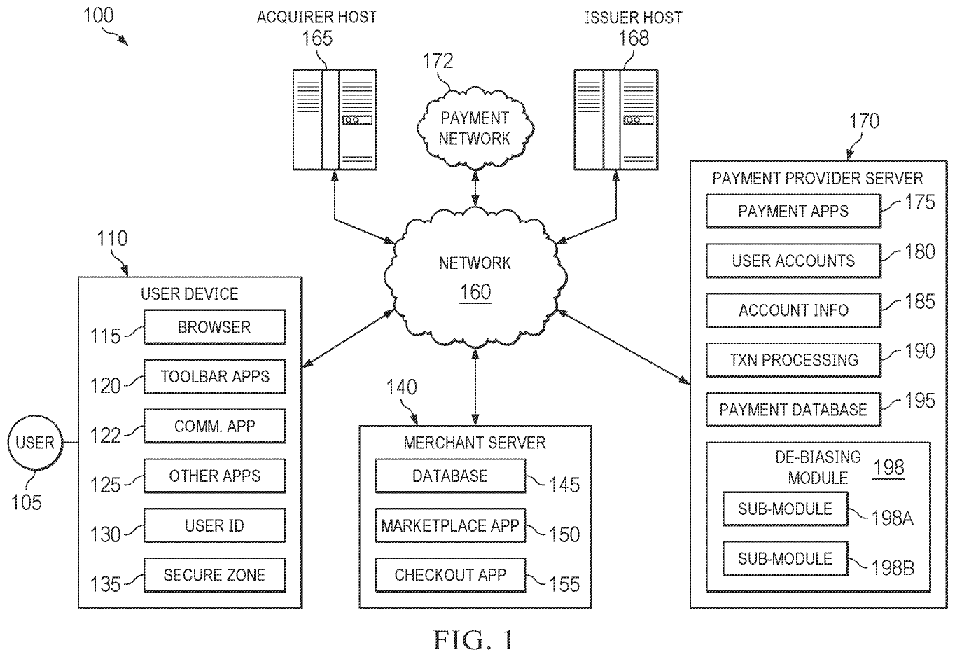

The output of the predictive model is then updated after the noise has been introduced to the predictive model. The updated output is less sensitive to the effects of the protected user attributes. One or more data features that contribute to a bias in the predictive model are also identified. To address the fairness issue, the identified one or more data features are deprioritized in an execution of the predictive model. One or more decisions involving the plurality of users are then made at least in part via the updated output of the predictive model. For example, a decision to grant or deny a predefined benefit (e.g., a loan or a line of credit) to a specific user or a group of users may be made based on the updated output of the predictive model. In this manner, the machine learning models of the present disclosure may be used to more accurately evaluate the riskiness of a predefined benefit (e.g., a loan or a line of credit) regardless of any traits that may conventionally be used that result in inaccurate predictions or outputs. The various aspects of the present disclosure are discussed in more detail with reference to FIGS. 1-9.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a digital wallet provider (e.g., a payment service provider), such as PayPal™, Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

According to various aspects of the present disclosure, the merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, third party financial service providers, such as associated with payment provider server 170, credit cards, debit cards, checks, money orders, or the like.

Payment provider server 170 may be maintained, for example, by an online digital wallet provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a de-biasing module 198 may also be implemented on the payment provider server 170. The de-biasing module 198 helps to remove biases from predictions associated with offering or approving one or more predefined benefits (e.g., a financial product, such as a loan or credit line) to the user 105 (where the user can be notified of the decision through the user device 110). The de-biasing module 198 may include one or more software applications or software programs that can be automatically executed (e.g., without needing explicit instructions from a human user) to perform certain tasks. For example, the de-biasing module 198 may utilize an adversarial model (e.g., as a type of a machine learning model) to introduce noise to a main predictive machine learning model, in order to lessen the contributions from data features (to the prediction made by the main predictive model) against one or more protected user attributes, such as race, gender, place of origin, religion, age, disability, sexual orientation, or pregnancy status, color, national origin, familial status, marital status, recipient of public assistance, etc. By doing so, the de-biasing module 198 can help the main predictive model reach a fairer decision (e.g., without biases against the one or more protected user attributes).

In some embodiments, the de-biasing module 198 comprises a plug-and-play module that is configured to work with a variety of different types of predictive models. For example, in some embodiments, the main predictive model is a LightGBM model, and the de-biasing module 198 can be overlaid on top of the LightGBM model (e.g., without requiring modifications to the computer source code of the LightGBM model) to help the LightGBM model make more optimized or accurate predictions (e.g., predictions with less bias against the one or more protected attributes). In other embodiments, the main predictive model is a machine learning model that is different from LightGBM, such as a classification model, a revenue prediction model, a recommender system model, a random forest model, or another type of suitable model. Regardless of the type of machine learning model used to implement the main predictive model, the de-biasing module 198 can still be overlaid on top of that main predictive model to help remove certain biases from the predictions made by the main predictive model.

In some embodiments, the de-biasing module 198 may include one or more sub-modules that are configured to perform specific tasks and/or have specified functionalities. For example, the de-biasing module 198 may include a sub-module 198A that is configured to store and/or execute computer source code of the adversarial models. As another example, the de-biasing module 198 may also include a sub-module 198B that is configured to identify data features that contribute to the biases against the one or more protected user attributes in the prediction made by the main predictive model. In other embodiments, functionalities of the modules 198A and 198B may at least partially overlap, and/or they may be integrated within the de-biasing module 198.

In any case, the main predictive model works in conjunction with the adversarial model of the de-biasing module 198 to more accurately predict the probability of an occurrence of an event associated with the users. For example, the main predictive model may output a prediction as to whether a particular user will fall behind or default on a particular loan or line of credit in a given period of time. With the help of the de-biasing module 198, the main predictive model can make these predictions while maintaining a certain fairness standard by de-prioritizing the contributions associated with one or more protected user attributes in making the prediction. By doing so, the de-biasing module 198 can help a digital wallet provider (and/or other suitable entities) make better (e.g., more informed) decisions (e.g., whether to offer a loan or a line of credit to a user) without requiring additional electronic data. As such, electronic resources (e.g., computer processing power, electronic memory usage, network bandwidth) that would have been wasted on submitting, receiving, and/or processing the additional electronic data are now preserved. Further, inaccurate predictions are reduced which reduces computing resources needed to remedy or address processing or decisions based on inaccurate outputs of the ML models. In this manner alone, the system 100 offers an improvement in computer technology.

It is noted that although the de-biasing module 198 is illustrated as being separate from the transaction processing application 190 in the embodiment shown in FIG. 1, the transaction processing application 190 may implement some, or all, of the functionalities of the de-biasing module 198 in other embodiments. In other words, the de-biasing module 198 may be integrated within the transaction processing application 190 in some embodiments. In addition, it is understood that the de-biasing module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the de-biasing module 198 may include one or more sub-modules that are configured to perform specific tasks. For example, the de-biasing module 198 may include a sub-module configured to generate the original underwriting model score and another sub-module configured to generate a revised (e.g., scaled up or down) underwriting model score.

Still referring to FIG. 1, the payment network 172 may be operated by payment card service providers or card associations, such as DISCOVER™, VISA™, MASTERCARD™ AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank or other financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

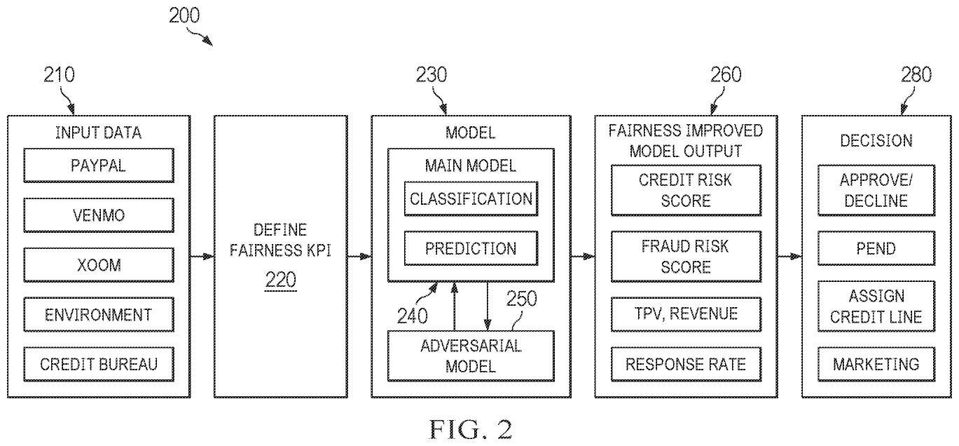

FIG. 2 illustrates a simplified block diagram of a process flow 200 in which the de-biasing module 198 discussed above with reference to FIG. 1 is utilized to help make more accurate predictions or decisions according to embodiments of the present disclosure.

The process flow 200 begins by accessing input data 210. The input data 210 may include data pertaining to a plurality of users (e.g., the user 105 of FIG. 1 and other similar users) from a plurality of data sources. As non-limiting examples, the data sources may include user data from payment providers or payment processors, such as “PayPal”, “Venmo”, “Xoom”. The user data may include user profile data, such as race, gender, ethnicity, age, location, occupation, employment status, income, disability, marital status, etc. The user data may also include data collected in association with transactions previously conducted by the users, such as payment instrument used, type of transaction (e.g., online or in a brick-and-mortar store), amount of transaction, items purchased, location of transaction, merchant involved in the transaction, etc. The input data 210 may also include data from an “Environment”, for example, economic indicators such as a Consumer Prices Index (CIPI), a jobless number, an interest rate, a stock market index, a home sales number, a retail sales number, an industrial output, a price of a commodity. The data from the “Environment” may also include non-economic indicators, such as indicators related to climate, demographics, geopolitics, ecology, legality, culture, society, etc. These economic or non-economic indicators may be collected by governmental agencies, universities, non-profit organizations, research institutes, and/or other suitable entities. The input data 210 may also include data from a “Credit Bureau”, for example, a credit history or a credit score from EQUIFAX™ or TRANSUNION™. In some embodiments, one or more types of the input data 210 discussed above may be maintained in an electronic database. In some embodiments, the input data 210 may be stored in the form of data features, which may be vectors having one or more dimensions. For example, a data feature may have a name that briefly describes what the underlying variable is, and/or a numeric value assigned to that data feature for a given user.

The process flow 200 continues in a step 220 by defining a fairness key performance indicator (KPI). In some embodiments, the fairness KPI may refer to a set of quantifiable measurements used to gauge an entity's overall long-term performance with respect to fairness. As an example, the fairness KPI may include a Disparate Impact (DI) ratio, which may be defined as a model score associated with a particular group of people (e.g., African American users) divided by a model score associated with people other than the particular group of people (e.g., users who are non-African Americans) in some embodiments. As another example, the fairness KPI may include a value that measures a demographic parity, which states that the proportion of each segment of a protected class (e.g., gender) should receive a positive outcome at equal rates. Other examples of the fairness KPI may include values that measure metrics such as equal opportunity, equal odds, predictive value parity, etc. Furthermore, in some embodiments, multiple protected attributes may be combined. For example, an African American woman who is older than 70 (which include race, gender, and age) may be considered having one merged protected attribute, rather than having three separate protected attributes.

The process flow 200 continues by inputting the input data 210 and the fairness KPI results from step 220 into a model 230. The model 230 may include a main model 240 (also referred to as a predictive model) and an adversarial model 250. The main model 240 may include a machine learning model capable of making predictions, for example, a prediction with respect to a likelihood of an occurrence of an event associated with one or more users. For example, the main model 240 can generate a prediction (as its output) in the form of a mathematical probability of a particular user (which may include an individual person or an entity/organization) defaulting on a financial product (e.g., a loan or a line of credit) if the financial product was offered to and accepted by the user. The financial product herein is merely a non-limiting example of a benefit that can be granted to a user. In other embodiments, the benefit granted to a user may be in the form of a predefined membership or status, reduced rates or fees, extended grace periods, etc., and the main model 240 can generate a prediction in the form of a probability of a negative outcome (or a positive outcome) if the predefined membership or status is granted to the user.

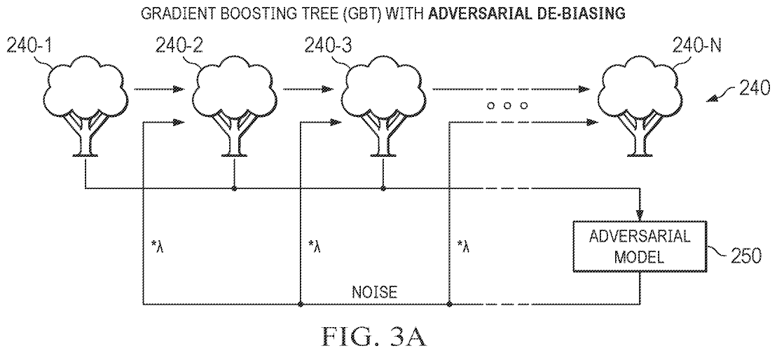

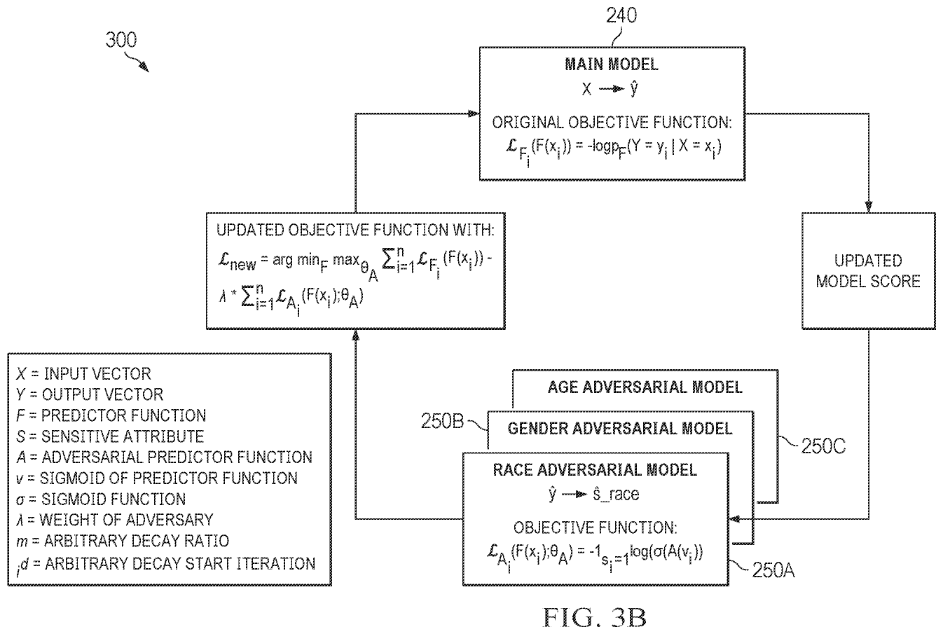

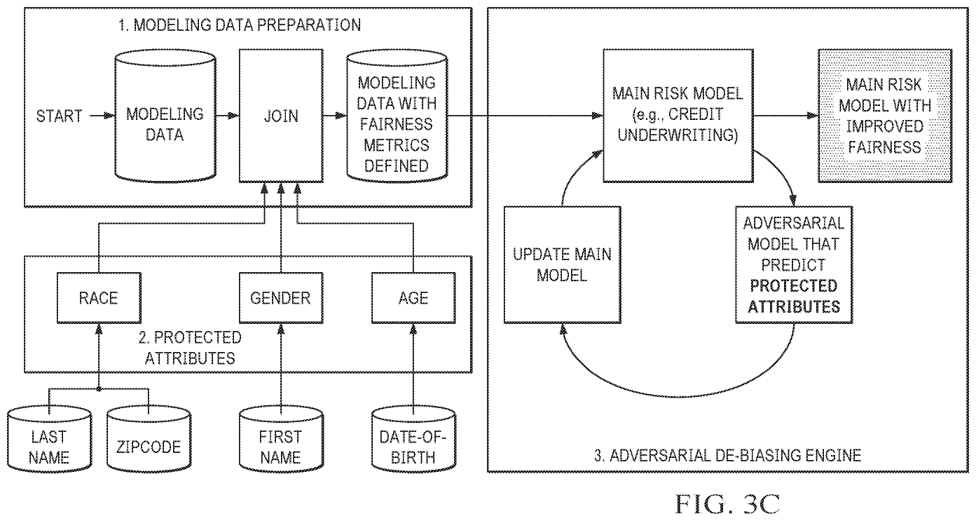

In some embodiments, the main model 240 may include a Light Gradient-Boosting Machine (LightGBM) model, which is a form of a Gradient Boosting Tree (GBT) model that includes a plurality of trees that are linked together on a chain. For example, FIG. 3A illustrates a simplified block diagram of the main model 240 implemented as a LightGBM model. The LightGBM model implementation of the main model 240 includes a plurality of trees, such as trees 240-1, 240-2, 240-3 . . . , and 240-N, where any number of trees may be implemented between the tree 240-3 and the tree 240-N. Each of the trees 240-1 through 240-N may be a predictor. For example, the first tree 240-1 may make a prediction about a decision (e.g., a yes or no decision regarding the approval of a loan to a user), then a second tree 240-2 (which is subsequent to the first tree 240-1 on the chain) is populated, where the second tree 240-2 tries to minimize and/or correct mistakes made by the first tree 240-1. The prediction results of the second tree 240-2 are then fed to the third tree 240-3, which then tries to minimize and/or correct mistakes made by the second tree 240-2, so on and so forth. In various embodiments, a total number of the trees contained in the main model 240 may be generally correlated with the desired accuracy of the predictions. It is understood that although LightGBM is used as an embodiment of the main model 240 herein, non-LightGBM machine learning models may be used in other embodiments. For example, any machine learning methods that use “gradient descent” can be used to implement the main model 240. As non-limiting examples, the methods that use “gradient descent” may include logistic regression, neural networks, decision tree, gradient boosting tree (GBT), and support vector machines.

Referring now to both FIG. 2 and FIG. 3A, the adversarial model 250 works in conjunction with the main model 240 to remove biases against certain protected user attributes in predictions made by the main model 240. In some embodiments, a different adversarial model 250 may be implemented and customized for each type of protected user attribute. These adversarial models 250 may be implemented to operate in parallel to one another.

In some embodiments, the adversarial model 250 introduces noise (e.g., in the form of a gradient noise) to the main model 240. For example, the adversarial model 250 may receive, as its input, the output from the main model 240 (e.g., the predictions with respect to a probability of an occurrence of an event, such as a loan default for a given user). Such an input into the adversarial model 250 may contain information pertaining to the protected user attributes as well, such as race, gender, etc. Based on the received input, the adversarial model 250 outputs noise, which is fed back into the main model 240 as inputs. In some embodiments, the noise outputted by the adversarial model 250 includes wrong guesses pertaining to the protected user attributes. In some embodiments, the noise outputted by the adversarial model 250 maximizes a loss associated with a prediction produced by the main model 240, when the prediction is based on a protected attribute. In embodiments where the main model 240 is implemented using a plurality of trees on a chain (e.g., in the case of a LightGBM model), a preceding tree (e.g., the tree 240-1 of FIG. 3A) may output a prediction, which is fed into the adversarial model 250. The adversarial model 250 then makes a guess (e.g., a guess with a built-in bad accuracy with respect to the protected user attribute), and that guess is fed back into a subsequent tree (e.g., the tree 240-2 of FIG. 3A) on the chain as an input (e.g., an input containing noise) to the subsequent tree. In some embodiments, the adversarial model 250 gets one input, which is the gradient of the main model 240. This one input reflects information pertaining to the protected attributes.

It is understood that one of the goals herein is for the adversarial model 250 to produce as inaccurate of a prediction as possible with respect to the guesses pertaining to the protected user attributes, which in turn prevents the main model 240 from deriving information pertaining to the protected user attributes. Such a noise introduction process may be performed for a plurality of cycles, where each cycle includes the adversarial model 250 receiving input (e.g., a prediction from the main model 240) and outputting noise back to the main model 240, which then outputs an updated prediction as its updated output. The more cycles are performed, the greater the extent the main model 240 is de-biased. In other words, the prediction outputted by the main model 240 is less influenced by data features associated with the users' protected attributes.

In some embodiments, the noise introduction process discussed above also includes determining a decay function to the introduced noise, such that an increasingly smaller amount of noise is introduced. For example, the decay function may be represented by Lambda in FIG. 3A. The noise generated by the adversarial model 250 is attenuated by the decay function (e.g., represented by “Lambda” being implemented on the path of the “Noise” back to each of the trees of the main model 240). In this manner, the decay function can decrease the learning rate of the adversarial model 250, so that it does not cause an excessive performance drop of the main model 240. In other words, without the implementation of the decay function, the adversarial model 250 may be able to help the main model 240 achieve a thorough de-biasing, but that may come at the expense of the performance of the main model 240. As such, the decay function herein may create an optimized tradeoff between fairness (e.g., in terms of the thoroughness of de-biasing) and performance (e.g., in terms of the prediction accuracy of the main model 240).

In some embodiments, the decay function is performed by ramping down the introduced noise after a predefined number of iterations (e.g., a hundred) of noise-introduction has been executed. In some embodiments, a different decay function is customized to each adversarial model of the plurality of adversarial models. For example, a first decay function is determined for an adversarial model that is customized for age as a protected user attribute, a second decay function is determined for an adversarial model that is customized for gender as a protected user attribute, a third decay function is determined for an adversarial model that is customized for race as a protected user attribute, so on and so forth. The different decay functions allow more optimized tuning of the adversarial models, since each adversarial model can be finely tuned based on the weight given to them via the decay functions.

As discussed above, the adversarial model 250 may include a plurality of models that are each associated with the de-biasing of a different type of protected user attribute. A simplified example 300 of this is illustrated in FIG. 3B, where additional details between the interaction of the main model 240 and a plurality of separately-customized adversarial models 250A, 250B, and 250C are illustrated. In this simplified example, the adversarial model 250A corresponds to an adversarial model for de-biasing race as a protected user attribute, the adversarial model 250B corresponds to an adversarial model for de-biasing gender as a protected user attribute, and the adversarial model 250C corresponds to an adversarial model for de-biasing age as a protected user attribute.

In FIG. 3B, “X” represents an input vector (e.g., data features) for the main model 240, “Y” represents an output vector for the main model 240, “F” represents a predictor function for the main model 240, “S” represents a sensitive attribute (e.g., a protected attribute such as age, gender, race, or other attributes meeting a predefined classification), “A” represents an adversarial predictor function of the adversarial models 250A-250C, “v” represents a sigmoid of the predictor function, “o” represents a sigmoid function, “2” represents a weight of adversary (e.g., the decay function discussed above), “m” represents an arbitrary decay ratio associated with the decay function, and “id” represents an arbitrary decay start iteration.

The main model 240 and the adversarial models 250A-250C may each have one or more objective functions, respectively. In that regard, an objective function may define at least one of the goals of the associated model. For example, the objective function of the main model 240 may be to minimize prediction loss (e.g., minimize the number or percentage of incorrect predictions generated by the main model), and the objective functions of the adversarial models 250A-250C may be to introduce a noise to the main model 240 based on a protected user attribute. As simplified examples, the original objective function of the main model 240 may include a mathematical formula of [symbol] _{F}_{ᵢ}(F(xᵢ))=−log p_{F}(Y=yᵢ|X=xᵢ), the objective function of the adversarial model 250A (for de-biasing “race” as a protected user attribute) may include a mathematical formula of [symbol] _{A}_{ᵢ}(F(Xᵢ); θ_{A})=−1ₛ_{ᵢ}₌₁ log (σ(A(vᵢ)). The adversarial models 250A, 250B, and 250C may receive the output (a prediction in the form of a model score) from the main model 240 and then may produce updated objective functions, which are fed back to the main model 240 as its input again. For example, the adversarial model 250A may output an updated objective function that contains a mathematical formula of [symbol] _{new}=arg min_{F} max_{θ}_{_{A}} Σᵢ₌₁ⁿ [symbol] _{F}_{ᵢ}(F(Xᵢ))−λ*Σᵢ₌₁ⁿ [symbol] _{A}_{ᵢ}(F(xᵢ); θ_{A}).

The loop involving the main model 240 and the adversarial models 250A/250B/250C may continue for a number of cycles. In some embodiments, the trees of the LightGBM model (e.g., as an embodiment of the main model 240) are not updated or changed, but that new trees are added to the chain of FIG. 3A. In other words, each de-biasing cycle may correspond to the addition of a new tree to the existing LightGBM model. In such a manner, the adversarial model 250 may be considered a plug-and-play model to an existing machine learning model (e.g., the main model 240), since it does not require modification of the computer source code of the existing machine learning model.

Referring back to FIG. 2, after a desired number of de-biasing cycles have been performed, the main model 250 generates a fairness improved model output 260. As non-limiting examples, the fairness improved model output 260 may include predictions pertaining to a credit risk score, a fraud risk score, a total payment volume (TPV), a revenue, or a response rate. Due to the performance of the de-biasing processes discussed above, the fairness improved model output 260 may contain predictions that are substantially less biased against users with one or more of the protected user attributes discussed above and thus more accurate. For example, after age is de-biased, the credit risk score prediction (as an example fairness improved model output 260) may not be significantly different for a user A who is 20 years of age, a user B who is 40 years of age, and a user C who is 60 years of age, assuming the other factors (e.g., annual income) are approximately equal among these users.

The fairness improved model output 260 is then used to generate one or more decisions 280. As non-limiting examples, the decisions 280 may include a decision to approve or decline a loan for a user, a decision to hold a user request (e.g., a user request for a loan) as pending (e.g., pending the acquisition of additional user information), a decision to assign a credit line, a decision to reduce fees, a decision to extend a grace period, or a marketing decision. These decisions 280 are more accurate, since they de-bias protected user attributes that do not contribute to the riskiness of the user for the benefit. Meanwhile, the decisions 280 are made without meaningfully sacrificing performance.

Based on the above discussions, it can be seen that the de-biasing scheme of the present disclosure has at least the following features:
1. Debiasing on multiple protected attributes: instead of debiasing on only 1 attribute, the present disclosure can de-bias multiple attributes in parallel.
2. Multiclass de-biasing: a de-biasing/fairness metric is developed that deals with the multiclass nature of the protected attribute, which is also done concurrently, as opposed to one attribute at a time.
3. Reweighting the protected attributes: A reweighting is performed for each of the additional protected attributes, which can be used to assign priorities to specified attributes for which de-biasing needs to be performed. For example, a novel fairness metric is introduced that specifically accounts for the multiclass nature of protected attributes. The reweighting mechanism for additional protected attributes allows priorities to be assigned to specific attributes that require de-biasing.
4. Protected attribute deviation: In situations where the protected attributes were not readily available, prediction techniques may be employed. For example, genders may be predicted based on first names, and races may be predicted using zip codes and surnames. These prediction techniques enable protected attributes to be derived even when they were not initially provided, thereby enhancing the versatility of the methods herein.

FIG. 3C illustrates a process flow according to an embodiment of the present disclosure. The flow starts by modeling data as a part of modeling data preparation. The modeling data is joined by protected attributes, which may include things such as race, gender, age, etc., as discussed above. In some embodiments, information such as a person's last name or zip code may be correlated with the person's race, a person's first name may be correlated with the person's gender, and a date of birth (dob) may be correlated with a person's age. Fairness metrics (e.g., the DI ratio, as a non-limiting example discussed above) may be defined for the modeling data that is joined with the protected attributes. The modeling data is then sent to the main risk model (e.g., as a credit underwriting model), which is a part of an adversarial de-biasing engine. The adversarial de-biasing engine also includes an adversarial model that predicts protected attributes based on the output of the main risk model. In some embodiments, the main risk model is implemented using the main model 240 of FIG. 2, and the adversarial model is implemented using the adversarial model 250 of FIG. 2. As discussed above with reference to FIG. 2, the output of the adversarial model is used to update the main risk model, whose updated output is then fed into the adversarial model again. Such a loop may continue for a specified number of iterations, which helps to de-bias the main risk model. The final output of the main risk model is then used to make certain decisions with improved fairness.

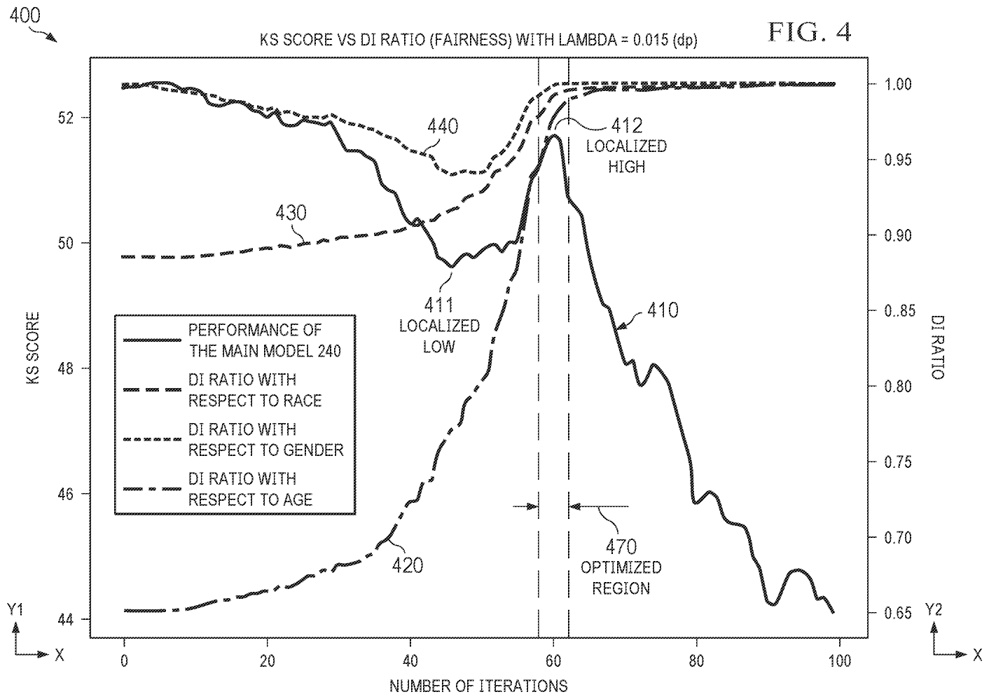

Referring now to FIG. 4, a graph 400 illustrates a relationship between performance and fairness. In more detail, the graph 400 includes two Y-axes (e.g., a Y1 axis on the left and a Y2 axis on the right) and an X-axis. In this embodiment, the Y1-axis corresponds to a Kolmogorov-Smirnov (KS) score, which represents a performance of the main model 240 (e.g., how accurate it is). The higher the KS score, the better the model performance (e.g., the model 240 can generate more accurate predictions). The Y2-axis represents a DI (Disparate Impact) ratio, which represents a fairness metric. In some embodiments, the DI ratio may be defined as a model score associated with a particular group of people (e.g., African American users) divided by a model score associated with people other than the particular group of people (e.g., users who are non-African Americans) in some embodiments. Generally, the higher the DI ratio, the more accurate the prediction generated by the model 240. As discussed above, although the DI ratio is used as a non-limiting example to represent the fairness metric in the example herein, other types of fairness metrics (e.g., other than the DI ratio) may be used in various embodiments, including demographic parity, equal opportunity, equal odds, predictive value parity, etc.

The X-axis is the number of de-biasing iterations. As discussed above, each de-biasing iteration may include a cycle in which the output of the main model 240 is inputted to the adversarial model 250, which generates noise that is fed back into the main model 240. The main model 240 can then generate a revised output that is fed into the adversarial model 250 again. The revised output of the main model 240 may include the subsequent model scores with reflection of the noise. The original output may be revised by adding additional noise (e.g., gradient) from the adversarial model 250 to the existing noise (e.g., gradient) made from main model 240, which is what drives the revised output to become increasingly more fair. In some embodiments where the main model 240 includes a tree-based machine learning model, the number of iterations represented by the X-axis herein corresponds to the number of additional trees added by the adversarial model 250 to the tree-based machine learning model.

The graph 400 illustrates a curve 410 that represents the performance of the main model 240 versus an extent of de-biasing. In other words, the curve 410 is a plot of the KS score (Y1-axis) versus the number of de-biasing iterations (X-axis). Based on the behavior of the curve 410, it can be seen that the performance of the main model 240, as measured by the KS score, is fairly accurate (e.g., with a KS score of greater than 52) when no de-biasing is implemented (e.g., at 0 number of de-biasing iterations). As de-biasing is implemented (e.g., the number of de-biasing iterations increases), the performance of the main model 240 begins to drop, until a localized low 411 (e.g., with a KS score of slightly less than 50) is reached at around 45 de-biasing iterations. After this localized low 411, the performance of the main model 240 begins to increase, until a localized high 412 (e.g., with a KS score of between 51 and 52) is reached at around 60 de-biasing iterations. Thereafter, the performance of the main model 240 begins to deteriorate somewhat rapidly and drops to a KS score of about 44 when 100 de-biasing operations have been performed.

Meanwhile, the graph 400 also illustrates curves 420, 430, and 440 that represent the fairness of the main model 240 versus an extent of de-biasing. In more, the curve 420 is a plot of the DI ratio (Y2-axis) with respect to age as a protected user attribute versus the number of de-biasing iterations (X-axis), the curve 430 is a plot of the DI ratio (Y2-axis) with respect to race as a protected user attribute versus the number of de-biasing iterations (X-axis), and the curve 440 is a plot of the DI ratio (Y2-axis) with respect to gender as a protected user attribute versus the number of de-biasing iterations (X-axis). Based on the behavior of the curve 420, it can be seen that the fairness of the main model 240 with respect to age is quite poor (e.g., with a DI ratio of about 0.65) when no de-biasing is implemented. As de-biasing is implemented (e.g., the number of de-biasing iterations increases), the fairness of the main model 240 with respect to age begins to improve, until a region 470 of the graph 400 is reached. After the region 470, the fairness of the main model 240 with respect to age begins to plateau, even if more de-biasing operations are performed. Similarly, the behavior of the curve 430 indicates that the fairness of the main model 240 with respect to race is quite suboptimal (with a DI ratio of about 0.9) when no de-biasing is implemented. As de-biasing is implemented (e.g., the number of de-biasing iterations increases), the fairness of the main model 240 with respect to race begins to improve, until the region 470 of the graph 400 is reached. After the region 470, the fairness of the main model 240 with respect to race also begins to plateau, even if more de-biasing operations are performed. Based on the behavior of the curve 440, it can be seen that the fairness of the main model 240 with respect to gender is already relatively good (e.g., with a DI ratio of close to 1) when no de-biasing is implemented. As de-biasing is implemented (e.g., the number of de-biasing iterations increases), the fairness of the main model 240 with respect to gender actually worsens (e.g., dipping to a low between 0.9 and 0.95 in terms of the DI ratio) but improves again as more de-biasing iterations are performed. However, like the curves 420 and 430, the fairness of the main model 240 with respect to gender also plateaus after the region 470 of the graph 400 is reached.

Based on the graph 400, a determination may be made that an optimal number of iterations to perform may be in (or near) the region 470. For example, at about 60 iterations of de-biasing, the performance of the main model 240 is still fairly good, as reflected by a KS score of close to 52. This is not a significant drop off from the initial KS score of a little over 52 when no de-biasing is performed. Meanwhile, the fairness metric for age, race, and gender are also relatively good, particularly with respect to race and age, which have been improved significantly (based on the increase in the DI ratio) at around 60 de-biasing iterations compared to when no de-biasing iterations were performed. Of course, the exact number of de-biasing iterations may be determined differently based on many different considerations, for example, the relative importance of performance versus fairness, and/or which of the protected user attributes is more important to de-bias compared to others, as well as the exact behavior of these variables in other graphs similar to the graph 400. It is also noted that the graph 400 is generated based on a lambda (e.g., the decay function) of 0.015 in this simplified example. It is understood that using different lambda values may result in graphs with different characteristics (and therefore a different determination for an optimized number of de-biasing iterations) in other embodiments.

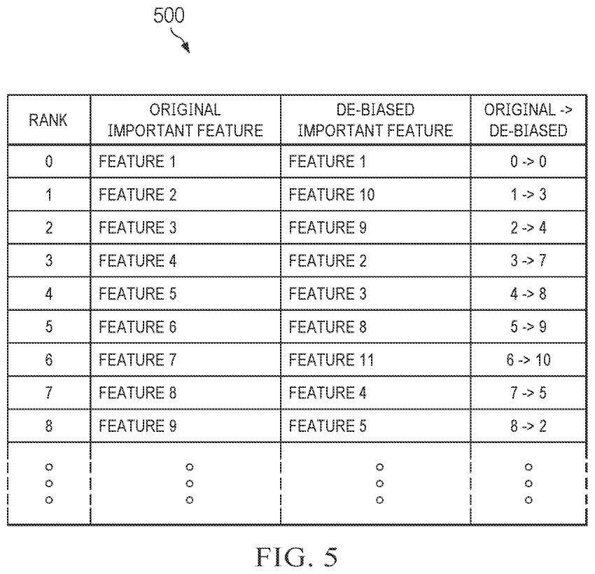

FIG. 5 is a chart 500 that illustrates the rankings of subsets of the data features before and after the de-biasing process discussed above has been performed. For example, the chart 500 lists the top 9 data features (e.g., “Original Important Feature”) that were deemed important for influencing the prediction made by the main model 240 before the de-biasing process discussed above has been performed. The chart 500 also lists the top 9 data features (e.g., “Debiased Important Feature”) that were deemed important for influencing the prediction made by the main model 240 after the de-biasing process discussed above has been performed. It can be seen that these two lists are not identical, as the importance of some of the data features may move up (e.g., Feature 9 moving from rank 8 to rank 2) or down (Feature 2 moving from rank 1 to rank 3), after the performance of the de-biasing process, even if the importance of some of the data features stay the same (e.g., Feature 1 staying from rank 0 to rank 0). In some embodiments, some of the originally important data features are identified as having an outsized contribution to biasing (e.g., a contribution exceeding a predefined threshold). For example, these data features may be identified by the sub-module 198B of the de-biasing module 198 of FIG. 1. In some embodiments, the identification and comparison of top features occur post optimized model determination, as shown in the chart 500. Once identified, these data features may be deprioritized. For example, these data features may not be used by the main model 240 for making a subsequent prediction, or they may be assigned a lower weighting.

Based on the above discussions, it can be seen that there are at least two aspects of the present disclosure. One of the aspects of the present disclosure pertains to reducing bias in a main predictive model (e.g., the model 240 discussed above). Another aspect of the present disclosure pertains to determining feature/variable importance (e.g., ranking the features/variables in terms of their importance and/or impact with respect to contributing to the bias against any given protected attribute. For example, the present disclosure is able to extract the features/variables that contributed to bias in the main predictive model at the end of the debiasing process (e.g., after all the iterations of exchanges between the main predictive model and the adversarial model discussed above are over).

The de-biasing described in the present disclosure is a practical application of the idea of improving accuracy and performance in machine learning. In such a practical application, the output of a main predictive model is inputted to an adversarial model, which outputs noise back to the main predictive model, such that the revised prediction generated by the main predictive model is less influenced by protected user attributes (e.g., age, gender, race, etc.). The end result is an improved main predictive model that can generate predictions that are less biased against users with one or more of the protected attributes and thus more accurate. Furthermore, the present disclosure is an improvement of computer technology, as conventional methods and techniques lack the capability to perform parallel de-biasing. For example, multiple different adversarial models may operate in parallel herein to de-bias multiple different protected user attributes simultaneously, where a different de-biasing model may be customized for a given protected user attribute. Such a parallel de-biasing scheme improves the de-biasing model efficiency and versatility. In addition, the adversarial models herein may be plug-and-play models that can operate in conjunction with a plurality of different types of main predictive models. For example, the adversarial models herein do not require a modification of the computer source code of the original main predictive model. Instead, the adversarial models may add new functionalities or other computer code to the main predictive model to achieve the de-biasing scheme herein. The removal of the adversarial model does not affect the original functionality of the main predictive model either.

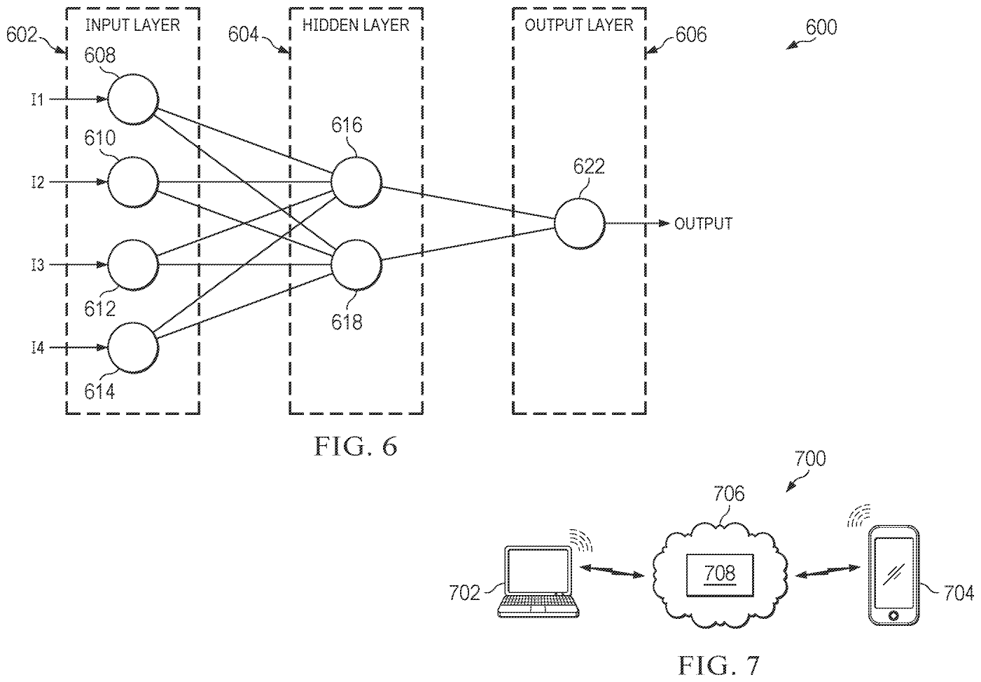

As discussed above, machine learning may be used to construct and/or implement the main model 240 or the adversarial model 250 of FIG. 2, or portions thereof. In some embodiments, the machine learning may be performed at least in part via an artificial neural network, which may be used to implement a machine learning module that can perform various machine learning processes. In that regard, FIG. 6 illustrates an example artificial neural network 600. As shown, the artificial neural network 600 includes three layers—an input layer 602, a hidden layer 604, and an output layer 606. Each of the layers 602, 604, and 606 May include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the de-biasing module 198, and the de-biasing module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct data feature.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., a loan becoming bad due to missed payments or a loan default).

The artificial neural network 600 may be trained by using training data. For example, the training data herein may be the previous bad loans and their corresponding user data. By providing training data to the artificial neural network 600, the nodes 616-618 in the hidden layer 604 may be trained (adjusted) such that an optimal output is produced in the output layer 606 based on the training data. By continuously providing different sets of training data, and penalizing the artificial neural network 600 when the output of the artificial neural network 600 is incorrect (e.g., when the determined (predicted) likelihood of a bad loan is inconsistent with whether the loan actually became bad, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm-which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the de-biasing module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the various processes discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

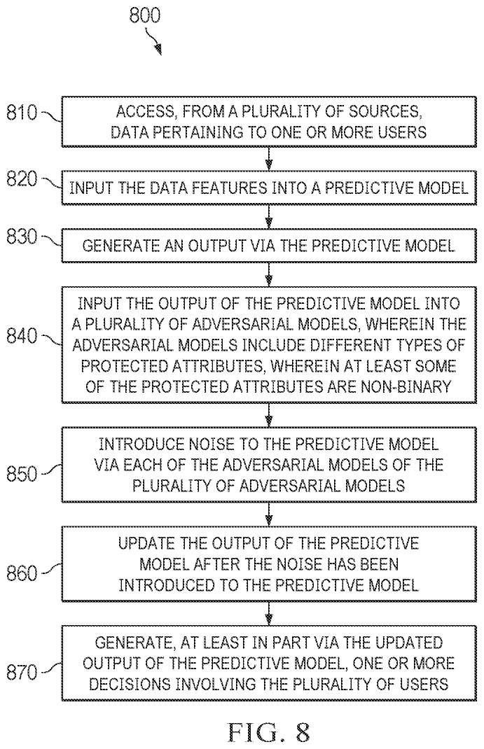

FIG. 8 is a flowchart illustrating a method 800 for generating a more accurate prediction or decision by de-biasing against one or more sensitive protected user attributes according to various aspects of the present disclosure. The various steps of the method 800, which are described in greater detail above, may be performed by one or more electronic processors, for example by the processors of a computer of an entity that may include (but are not limited to): a payment provider, a business analyst, or a merchant. The networked system described with respect to FIG. 1 is an example of a system that can perform the method 800. For example, the steps 810-870 of the method 800 may be performed by the payment provider server 170 of FIG. 1. In some embodiments, at least some of the steps of the method 800 may be performed by the de-biasing module 198 discussed above. For example, steps 810-860 of the method 800 may be performed by the de-biasing module 198 of FIG. 1, while step 870 of the method 800 may be performed by the de-biasing module 198 in some embodiments, or the step 870 may be performed by another component (e.g., the transaction processing application 190) of the payment provider server 170 of FIG. 1 in other embodiments.

The method 800 includes a step 810 to access, from a plurality of sources, data pertaining to a plurality of users. In some embodiments, the data pertaining to the one or more users comprise credit bureau data, digital wallet data, or user profile data, etc., as described with reference to the input data 210 of FIG. 2 above.

The method 800 includes a step 820 to inputting the data features into a predictive model. This step may correspond to the feeding of the input data 210 into the model 230 of FIG. 2 discussed above. The predictive model may be implemented using the main model 240 of FIG. 2.

The method 800 includes a step 830 to generate an output via the predictive model, for example, by the main model 240 of FIG. 2 discussed above. In some embodiments, the predictive model comprises a Light Gradient Boosting Machine (LightGBM) model that includes a plurality of trees on a chain (see FIG. 3A). In some embodiments, the output of the predictive model comprises a predicted probability of an occurrence of an event. For example, the event may be the likelihood of a user defaulting on a loan or a line of credit or delaying payments. The one or more decisions are generated based on the predicted probability of the occurrence of the event.

The method 800 includes a step 840 to input the output of the predictive model into a plurality of adversarial models. For example, the adversarial models may include the adversarial model 250 of FIGS. 2-3 and/or the adversarial models 250A/250B/250C of FIG. 3B.

The adversarial models include different types of protected attributes, such as race, ethnicity, gender, place of origin, religion, age, disability, sexual orientation, pregnancy status, color, national origin, familial status, marital status, recipient of public assistance, etc. At least some of the protected attributes are non-binary, for example, age is a non-binary protected attribute.

The method 800 includes a step 850 to introduce noise to the predictive model via each of the adversarial models of the plurality of adversarial models. In some embodiments, the noise is introduced at least in part by determining a decay function (see lambda of FIGS. 3A-3B discussed above) for the introduced noise. In some embodiments, the decay function is performed by ramping down the introduced noise after a predefined number of iterations of noise-introduction has been executed. In some embodiments, a different decay function is customized to each adversarial model of the plurality of adversarial models.

The method 800 includes a step 860 to update the output of the predictive model after the noise has been introduced to the predictive model. For example, the main model 240 of FIG. 2 is updated based on the noise introduced by the adversarial model 250. The updated main model 240 is less influenced by data features that could otherwise contribute to a bias related to one of the protected user attributes discussed above. In some embodiments, the output herein may correspond to the improved or more accurate/fair model output 260 of FIG. 2.

The method 800 includes a step 870 to generate, at least in part via the updated output of the predictive model, one or more decisions involving the plurality of users. For example, one of the decisions 280 of FIG. 2 may be generated, such as approving or declining a loan, assigning a credit line, extending a grace period, reducing fees, etc.

In some embodiments, at least one the plurality of adversarial models includes a plug-and-play model that is configured to interact at least with the LightGBM model. In some embodiments, the output of the predictive model inputted into the plurality of adversarial models includes an output from a preceding tree on the chain; and the noise is introduced by the plurality of adversarial models to a subsequent tree on the chain, the subsequent tree being subsequent to the preceding tree.

In some embodiments, the output of the predictive model is inputted into the plurality of adversarial models in parallel with one another. The noise is introduced to the predictive model in parallel with one another via each of the adversarial models.

It is understood that additional method steps may be performed before, during, or after the steps 810-870 discussed above. For example, the method 800 may include a step of identifying, at least in part via a feature-identification module, one or more of the data features that contribute to a bias in the predictive model. For example, the feature-identification module may be implemented as the sub-module 198B of FIG. 1. As another example, the method 800 may further include a step of deprioritizing the identified one or more of the data features in an execution of the predictive model. For reasons of simplicity, these additional steps are not discussed in detail herein.

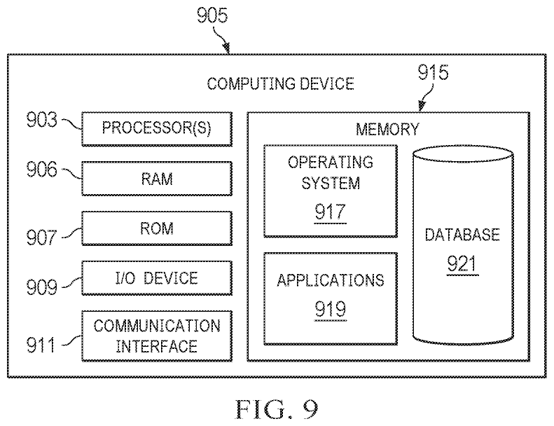

Turning now to FIG. 9, a computing device 905 that may be used with one or more of the computational systems is described. The computing device 905 may be used to implement various computing devices discussed above with reference to FIGS. 1-8. For example, the computing device 905 may be used to implement the de-biasing module 198 (or portions thereof) of FIG. 1, and/or other components (e.g., the transaction processing application 190) of the payment provider server 170. Furthermore, the computing device 905 may be used to implement the user device 100, the merchant server 140, the acquirer host 165, the issuer host 168, or portions thereof, in various embodiments. The computing device 905 may include a processor 903 for controlling overall operation of the computing device 905 and its associated components, including RAM 906, ROM 907, input/output device 909, communication interface 911, and/or memory 915. A data bus may interconnect processor(s) 903, RAM 906, ROM 907, memory 915, I/O device 909, and/or communication interface 911. In some embodiments, computing device 905 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 909 may include a microphone, keypad, touch screen, and/or stylus motion, gesture, through which a user of the computing device 905 may provide input, and may also include one or more speakers for providing audio output and a video display device for providing textual, audiovisual, and/or graphical output. Software may be stored within memory 915 to provide instructions to processor 903 allowing computing device 905 to perform various actions. For example, memory 915 may store software used by the computing device 905, such as an operating system 917, application programs 919, and/or an associated internal database 921. The various hardware memory units in memory 915 may include volatile and nonvolatile, removable and non-removable media implemented in any method or technology for storage of information such as computer-readable instructions, data structures, program modules, or other data. Memory 915 may include one or more physical persistent memory devices and/or one or more non-persistent memory devices. Memory 915 may include, but is not limited to, random access memory (RAM) 906, read only memory (ROM) 907, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 903.

Communication interface 911 may include one or more transceivers, digital signal processors, and/or additional circuitry and software for communicating via any network, wired or wireless, using any protocol as described herein.

Processor 903 may include a single central processing unit (CPU), which may be a single-core or multi-core processor, or may include multiple CPUs. Processor(s) 903 and associated components may allow the computing device 905 to execute a series of computer-readable instructions to perform some or all of the processes described herein. Although not shown in FIG. 9, various elements within memory 915 or other components in computing device 905, may include one or more caches, for example, CPU caches used by the processor 903, page caches used by the operating system 917, disk caches of a hard drive, and/or database caches used to cache content from database 921. For embodiments including a CPU cache, the CPU cache may be used by one or more processors 903 to reduce memory latency and access time. A processor 903 may retrieve data from or write data to the CPU cache rather than reading/writing to memory 915, which may improve the speed of these operations. In some examples, a database cache may be created in which certain data from a database 921 is cached in a separate smaller database in a memory separate from the database, such as in RAM 906 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 905 are described separately, functionality of the various components may be combined and/or performed by a single component and/or multiple computing devices in communication without departing from the invention.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: accessing, from a plurality of sources, data features pertaining to a plurality of users; inputting the data features into a predictive model; generating an output via the predictive model; inputting the output of the predictive model into a plurality of adversarial models, wherein the adversarial models include different types of protected attributes, wherein at least some of the protected attributes are non-binary; introducing noise to the predictive model via each of the adversarial models of the plurality of adversarial models; updating the output of the predictive model after the noise has been introduced to the predictive model; and generating, at least in part via the updated output of the predictive model, one or more decisions involving the plurality of users.

Another aspect of the present disclosure involves a system that includes a non-transitory memory and one or more hardware processors coupled to the non-transitory memory and configured to read instructions from the non-transitory memory to cause the system to perform operations comprising: accessing, from a plurality of sources, data features pertaining to a plurality of users having a plurality of attributes, wherein at least a subset of the attributes each meets a specified classification; inputting the data features into a predictive model; generating an output via the predictive model, the output comprising a predicted probability of an occurrence of an event associated with the plurality of users; inputting the output of the predictive model into a plurality of adversarial models in parallel, wherein each of the adversarial models is configured to introduce noise with respect to a different one of the attributes in the subset of the attributes; revising the predictive model based on the noise introduced by the adversarial models; updating the output via the revised predictive model, wherein the updated output is less sensitive to the subset of the attributes; and generating, via the updated output, one or more decisions involving the plurality of users.

Yet another aspect of the present disclosure involves a non-transitory machine-readable medium having stored thereon machine-readable instructions executable to cause a machine to perform operations comprising: accessing, from a plurality of sources, data features pertaining to a plurality of users; inputting the data features into a predictive model; executing a plurality of de-biasing cycles, wherein the executing of each of the de-biasing cycles comprises: inputting an output of the predictive model into a plurality of adversarial models, wherein the adversarial models include different types of protected attributes of the plurality of users, wherein at least some of the protected attributes are non-binary; generating noise via the plurality of adversarial models; and updating the predictive model based on the generated noise; and predicting, via the predictive model after the plurality of de-biasing cycles have been executed, a likelihood of an occurrence of an event associated with at least a subset of the plurality of users; and generating, at least in part based on the predicting, one or more decisions involving at least the subset of the plurality of users.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, while protected attributes are described, non-protected attributes that may unfairly bias a user and have no bearing on a decision to offer a benefit or protect are also part of present disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing, from a plurality of sources, data features pertaining to a plurality of users;
inputting the data features into a predictive model;
generating an output via the predictive model;
inputting the output of the predictive model into a plurality of adversarial models, wherein the plurality of adversarial models include different types of protected attributes, wherein at least one or more of the protected attributes are non-binary;
introducing noise to the predictive model via each of the adversarial models of the plurality of adversarial models;
updating the output of the predictive model after the noise has been introduced to the predictive model; and
generating, at least in part via the updated output of the predictive model, one or more decisions involving at least one of the plurality of users.

2. The method of claim 1, further comprising: identifying, at least in part via a feature-identification module, one or more of the data features that contribute to a bias in the predictive model.

3. The method of claim 2, further comprising: deprioritizing the identified one or more of the data features in an execution of the predictive model.

4. The method of claim 1, wherein the predictive model comprises a Light Gradient Boosting Machine (LightGBM) model that includes a plurality of trees on a chain.

5. The method of claim 4, wherein at least one the plurality of adversarial models is a plug-and-play model that is configured to interact at least with the LightGBM model.

6. The method of claim 4, wherein:
the output of the predictive model inputted into the plurality of adversarial models includes an output from a preceding tree on the chain; and
the noise is introduced by the plurality of adversarial models to a subsequent tree on the chain, the subsequent tree being subsequent to the preceding tree.

7. The method of claim 1, wherein the introducing the noise further comprises determining a decay function for the introduced noise.

8. The method of claim 7, wherein the decay function is performed by ramping down the introduced noise after a predefined number of iterations of noise-introduction has been executed.

9. The method of claim 7, wherein a different decay function is customized to each adversarial model of the plurality of adversarial models.

10. The method of claim 1, wherein the output of the predictive model is inputted into the plurality of adversarial models in parallel with one another, and wherein the noise is introduced to the predictive model in parallel with one another via each of the adversarial models.

11. The method of claim 1, wherein the output of the predictive model comprises a predicted probability of an occurrence of an event, and wherein the one or more decisions are generated based on the predicted probability of the occurrence of the event.

12. A system comprising:
a processor; and
a non-transitory computer-readable medium having stored thereon instructions that are executable by the processor to cause the system to perform operations comprising:
accessing, from a plurality of sources, data features pertaining to a plurality of users having a plurality of attributes, wherein at least a subset of the attributes each meets a specified classification;
inputting the data features into a predictive model;
generating an output via the predictive model, the output comprising a predicted probability of an occurrence of an event associated with the plurality of users;
inputting the output of the predictive model into a plurality of adversarial models in parallel, wherein each of the adversarial models is configured to introduce noise with respect to a different one of the attributes in the subset of the attributes;
revising the predictive model based on the noise introduced by the adversarial models;
updating the output via the revised predictive model, wherein the updated output is less influenced by the subset of the attributes; and
generating, via the updated output, one or more decisions involving one or more of the plurality of users.

13. The system of claim 12, wherein at least some of the attributes in the subset of the attributes are non-binary.

14. The system of claim 12, wherein the operations further comprise:
identifying one or more of the data features that are associated with the subset of the attributes; and
deprioritizing the identified one or more of the data features in an execution of the predictive model.

15. The system of claim 12, wherein at least one the plurality of adversarial models is a plug-and-play model that does not require a modification to an original computer code of the predictive model.

16. The system of claim 12, wherein:
the predictive model comprises a Light Gradient Boosting Machine (LightGBM) model that includes a plurality of trees on a chain;
the output of the predictive model inputted into the plurality of adversarial models includes an output from a preceding tree on the chain; and
the noise is introduced by the plurality of adversarial models to a subsequent tree on the chain, the subsequent tree being subsequent to the preceding tree.

17. The system of claim 12, wherein:
an amount of noise introduced is specified by one or more decay functions; and
the one or more decay functions are customized to each adversarial model of the plurality of adversarial models.

18. A non-transitory machine-readable medium having stored thereon machine-readable instructions executable to cause a machine to perform operations comprising:
accessing, from a plurality of sources, data features pertaining to a plurality of users;
inputting the data features into a predictive model;
executing a plurality of de-biasing cycles, wherein the executing of each of the de-biasing cycles comprises:
inputting an output of the predictive model into a plurality of adversarial models, wherein the adversarial models include different types of attributes of the plurality of users, wherein at least some of the attributes are non-binary;
generating noise via the plurality of adversarial models; and
updating the predictive model based on the generated noise;
predicting, via the predictive model after the plurality of de-biasing cycles have been executed, a likelihood of an occurrence of an event associated with at least a subset of the plurality of users; and
generating, at least in part based on the predicting, one or more decisions involving at least the subset of the plurality of users.

19. The non-transitory machine-readable medium of claim 18, wherein the operations further comprise:
identifying one or more of the data features that contribute to a bias against one or more of the different types of attributes in the predictive model before the plurality of de-biasing cycles have been executed; and
deprioritizing the identified one or more of the data features in an execution of the updated predictive model.

20. The non-transitory machine-readable medium of claim 18, wherein:
the predictive model comprises a Light Gradient Boosting Machine (LightGBM) model that includes a plurality of trees on a chain;
the output of the predictive model inputted into the plurality of adversarial models includes an output from a last tree on the chain; and
the predictive model is updated by adding a new tree after the last tree on the tree, the new tree containing the noise generated by the plurality of adversarial models.
